(19) United States
(12) Patent Application Publication
(10) Pub. No.: US 2024/0196448 A1
(43) Pub. Date: Jun. 13, 2024

(54) ENHANCEMENT OF USER EQUIPMENT LOCATION FOR NON-3GPP ACCESS

(71) Applicant: QUALCOMM Incorporated, San Diego, CA (US)

(72) Inventors: Kefeng ZHANG, Beijing (CN); Yan LI, Beijing (CN); Zhimin DU, Beijing (CN)

(21) Appl. No.: 18/287,639

(22) PCT Filed: Jun. 15, 2021
(86) PCT No.: PCT/CN2021/100030

§ 371 Date: Oct. 19, 2023

(51) Int. Cl. H04W 76/10; H04L 65/1016; H04L 65/1073; H04W 4/14; H04W 64/00; H04W 84/12

(52) U.S. Cl. CPC H04W 76/10; H04L 65/1016; H04L 65/1073; H04W 4/14; H04W 64/00; H04W 84/12

(57) ABSTRACT

Aspects presented herein may enable a location of a UE accessing a network via non-3GPP access to be determined or estimated. In one aspect, a UE establishes a connection with at least one network entity and a non-network connection entity. The UE transmits, to the at least one network entity, an ID of the non-network connection entity when connected to the at least one network entity. The UE receives, from the at least one network entity, a request for a location of the non-network connection entity. The UE transmits, to the at least one network entity, an indication of location information for the non-network connection entity.

### TECHNICAL FIELD

The present disclosure relates generally to communication systems, and more particularly, to wireless communication involving user equipment (UE) positioning.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IOT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus establishes a connection with at least one network entity and a non-network connection entity. The apparatus transmits, to the at least one network entity, an identifier (ID) of the non-network connection entity when connected to the at least one network entity. The apparatus receives, from the at least one network entity, a request for a location of the non-network connection entity. The apparatus transmits, to the at least one network entity, an indication of location information for the non-network connection entity.

In an aspect of the disclosure, a method, a computer-readable medium, and an apparatus are provided. The apparatus establishes a connection with at least one UE. The apparatus receives, from the at least one UE, an ID of a non-network connection entity connected to the at least one UE. The apparatus transmits, to the at least one UE, a request for a location of the non-network connection entity. The apparatus receives, from the at least one UE, an indication of location information for the non-network connection entity. The apparatus updates, based on the received indication, a mapping table between the ID of the non-network connection entity and the location information for the non-network connection entity.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of a UE accessing network in accordance with various aspects of the present disclosure.

FIG. 5 is a communication flow illustrating an example of a network determining a UE's location based on a location of a non-network connection entity in accordance with various aspects of the present disclosure.

FIG. 6 is a communication flow illustrating an example of a UE reporting access point name (APN) information in an untrusted non-3GPP access protocol data unit (PDU) session establishment in accordance with various aspects of the present disclosure.

FIG. 7 is a flowchart of a method of wireless communication in accordance with aspects presented herein.

FIG. 8 is a flowchart of a method of wireless communication in accordance with aspects presented herein.

FIG. 9 is a diagram illustrating an example of a hardware implementation for an example apparatus in accordance with aspects presented herein.

FIG. 10 is a flowchart of a method of wireless communication in accordance with aspects presented herein.

FIG. 11 is a flowchart of a method of wireless communication in accordance with aspects presented herein.

FIG. 12 is a diagram illustrating an example of a hardware implementation for an example apparatus in accordance with aspects presented herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, implementations and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, aggregated or disaggregated components, end-user devices, etc. of varying sizes, shapes, and constitution.

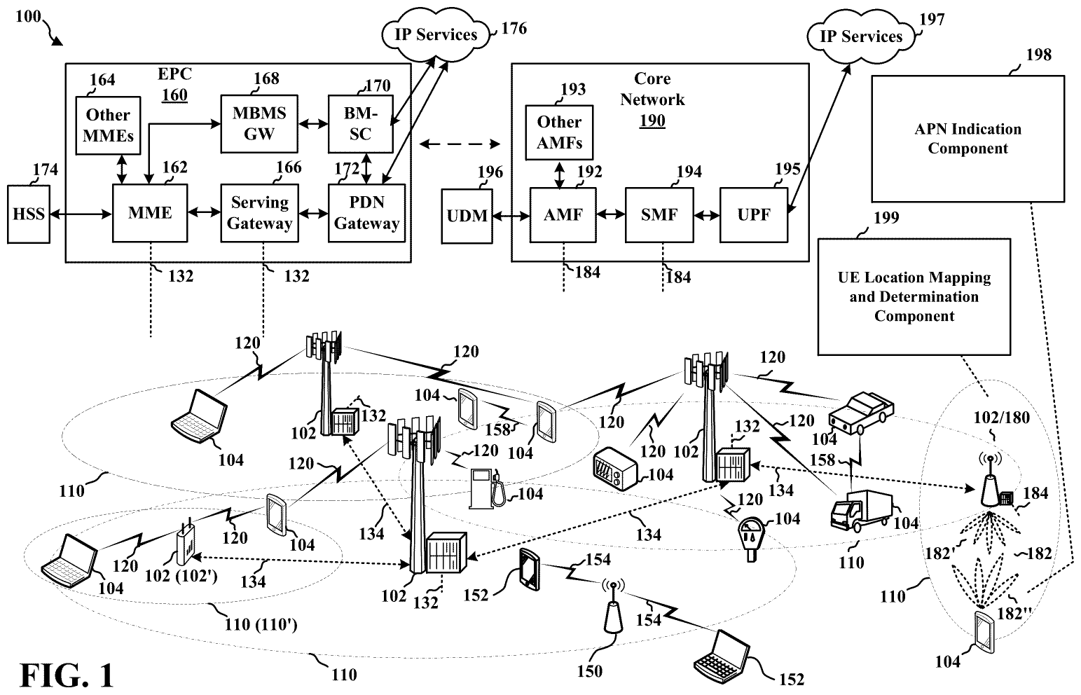

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

Aspects presented herein may enable a network, such as a core network (e.g., 5GC network) and/or an IMS network, to be able to derive location information of a UE accessing the network via a non-standardized access (e.g., a non-3GPP access). Aspects presented herein may enable a network to determine which public-safety answering point serves the area in which a UE may be located if the UE makes an emergency call using a non-standardized access.

In certain aspects, the UE 104 may include an access point name (APN) indication component 198 configured to indicate to a network an identifier (ID) associated with a non-3GPP access point (AP) in which that UE 104 is using for accessing the network, where the ID may be used by the network for deriving the UE 104's approximate location. In one configuration, the APN indication component 198 may be configured to establish a connection with at least one network entity and a non-network connection entity. In such configuration, the APN indication component 198 may transmit, to the at least one network entity, an ID of the non-network connection entity when connected to the at least one network entity. In such configuration, the APN indication component 198 may receive, from the at least one network entity, a request for a location of the non-network connection entity. In such configuration, the APN indication component 198 may transmit, to the at least one network entity, an indication of location information for the non-network connection entity.

In certain aspects, the base station 102/180 may include a UE location mapping and determination component 199 configured to maintain a mapping table between AP(s) accessed by a UE and location information associated with the AP(s), where the base station 102/180 may be able to derive or estimate the UE's location based on the mapping table if the UE is accessing the base station 102/180 via a non-3GPP access. In one configuration, the UE location mapping and determination component 199 may be configured to establish a connection with at least one UE. In such configuration, the UE location mapping and determination component 199 may receive, from the at least one UE, an ID of a non-network connection entity connected to the at least one UE. In such configuration, the UE location mapping and determination component 199 may transmit, to the at least one UE, a request for a location of the non-network connection entity. In such configuration, the UE location mapping and determination component 199 may receive, from the at least one UE, an indication of location information for the non-network connection entity. In such configuration, the UE location mapping and determination component 199 may update, based on the received indication, a mapping table between the ID of the non-network connection entity and the location information for the non-network connection entity.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHZ, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHZ-7.125 GHZ) and FR2 (24.25 GHz-52.6 GHz). Although a portion of FRI is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FRI and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FRI characteristics and/or FR2 characteristics, and thus may effectively extend features of FRI and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHZ), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHZ, may be within FRI, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

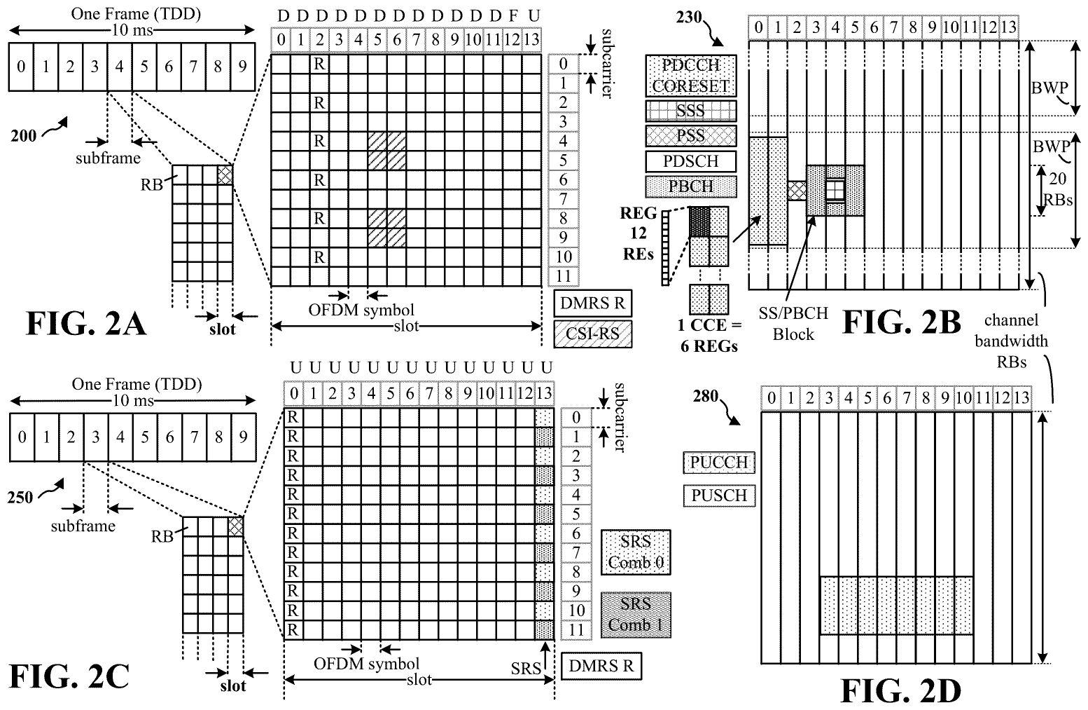

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | |
|---|---|---|
| μ | Δf = 2^{μ} · 15 [kHz] | Cyclic prefix |
| 0 | 15 | Normal |
| 1 | 30 | Normal |
| 2 | 60 | Normal, Extended |
| 3 | 120 | Normal |
| 4 | 240 | Normal |

For normal CP (14 symbols/slot), different numerologies μ0 to 4 allow for 1, 2, 4, 8, and 16 slots, respectively, per subframe. For extended CP, the numerology 2 allows for 4 slots per subframe. Accordingly, for normal CP and numerology u, there are 14 symbols/slot and 2^{μ} slots/subframe. The subcarrier spacing may be equal to 2^{μ}*15 kHz, where u is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 us. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme. As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

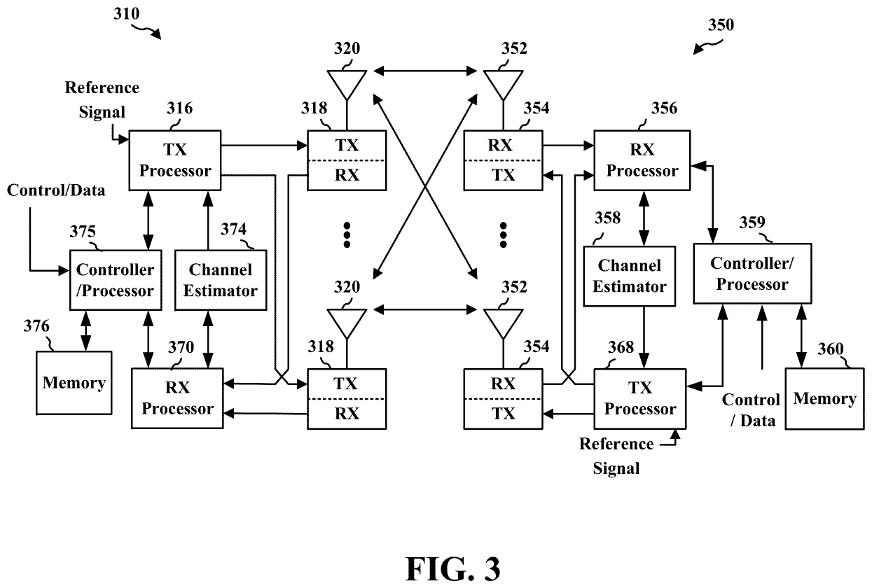

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318 TX. Each transmitter 318 TX may modulate a radio frequency (RF) carrier with a respective spatial stream for transmission.

At the UE 350, each receiver 354 RX receives a signal through its respective antenna 352. Each receiver 354 RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with the APN indication component 198 of FIG. 1.

At least one of the TX processor 316, the RX processor 370, and the controller/processor 375 may be configured to perform aspects in connection with the UE location mapping and determination component 199 of FIG. 1.

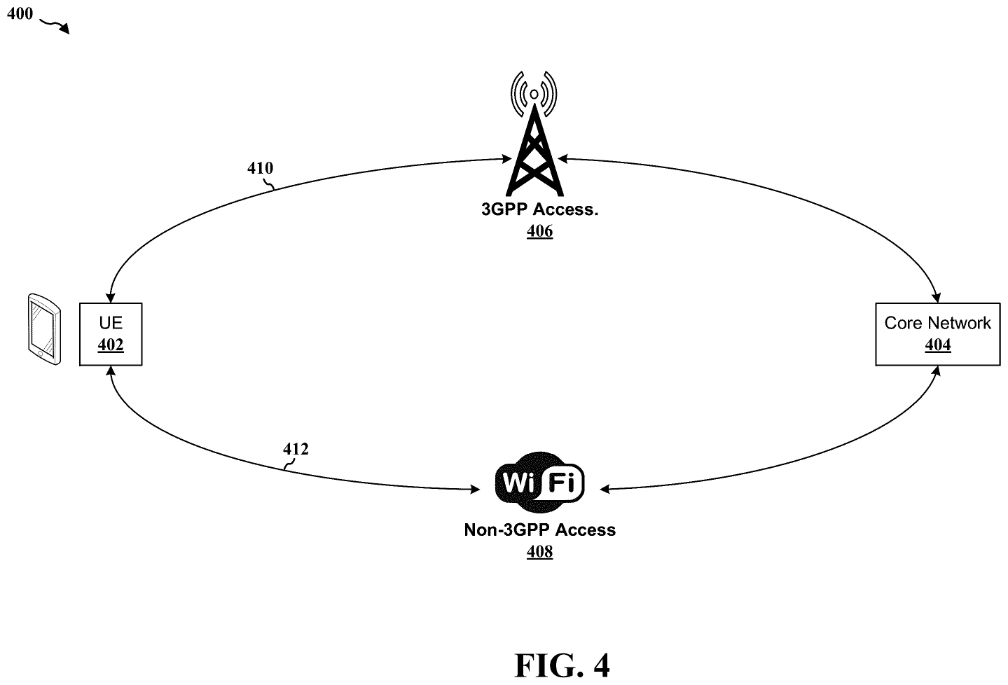

FIG. 4 is a diagram 400 illustrating an example of a UE accessing a network in accordance with various aspects of the present disclosure. As shown at 410, a UE 402 may access a network 404, such as a 5G Core (5GC) network, based on a 3rd Generation Partnership Project (3GPP) access 406 (e.g., a direct connection to a base station associated with the network). After the UE 402 is connected to the network 404 via the 3GPP access 406, the UE 402 may have access to services provided by the network 404, such as making calls, having access to the Internet, etc. In some examples, the network 404 may be able to identify or estimate the UE 402's location/position when the UE 402 accesses the network 404. In one example, when 3GPP access network is available, a UE or a network may trigger a cellular based location service via a location retrieval function (LRF) associated with the network, or via a gateway mobile location center (GMLC) for a UE connected in non-3GPP access, etc. In another example, a network access based on 3GPP standards may provide support for multi-/single-cell and/or device-based positioning for a UE, where reference signals (e.g., position reference signals (PRSs), sounding reference signals (SRSs), etc.) may be exchanged between a UE and one or more cells for calculating the roundtrip time (RTT), angle of arrival/departure (AoA/AOD), and/or time difference of arrival (TDOA) for the exchanged reference signals. Then, based on the calculated RTT, AoA/AOD, and/or TDOA, the network (or a location management function (LMF) associated with the network) may be able to determine or estimate the UE's location. In other examples, when a UE knows its location, such as based on Global Navigation Satellite System (GNSS) positioning mechanism or other means, the UE may report its location to the network, such that the network may determine the location of the UE.

If a UE's location is known to a network serving the UE, the network may provide the UE's location when the network is requested (and authorized) to do so. For example, when a UE is used for calling an emergency service (e.g., making an emergency call to a police station, a fire station, etc.), the network may be configured to report the location of the UE to entities associated with the emergency service. In some regions and/or countries, such configuration may be mandatory and regulated by local governments. For example, regulations in certain regions and/or countries may request mobile network operators (MNOs) to be able to provide at least approximate locations of network users (e.g., locations of UEs accessing their network) when network users make emergency calls in order for the MNOs to operate in the region or country.

Referring back to FIG. 4, in some examples, as shown at 412, the UE 402 may access the network 404 via a non-3GPP access 408 (e.g., an access that is not based on 3GPP access methods/technologies/networks/standards, etc.), which may include, and is not limited to, a wireless local area network (WLAN) access point (AP), WiMAX according to the standard IEEE 802.16, a WLAN according to the standard IEEE 802.11g/n, xDSL (Digital Subscriber Line), and/or fixed networks, etc. After the UE 402 is connected to the network 404 via the non-3GPP access 408, the UE 402 may also have access to services provided by the network 404, such as making calls, having access to the Internet, etc. For example, when a UE is connected to a 5GC via non-3GPP access, the UE may be able to make voice calls (e.g., have access to voice services) via an IP multimedia subsystem (IMS), which may also be referred to as “voice over Wi-Fi” (VoWiFi).

In some examples, if the UE 402 accesses the network 404 based on the non-3GPP access 408, the network 404 may not be able to identify the location of the UE 402. For examples, the UE 402 may connect to a Wi-Fi router in an indoor setting, where the UE 402 may not be able to determine its location based on GNSS and report its location to the network 404. As regulations in certain countries and/or regions may request MNOs to be able to provide at least approximate locations of network users when the network users make emergency calls, which may include calls that are made via the non-3GPP access 408 (e.g., the VoWiFi), an MNO may not be able to provide voice services to network users in which their locations are unable to be identified. In other words, in some examples, MNOs may not be able to comply with regulatory specifications of emergency services, e.g., when commercializing VoWiFi.

In other examples, an access network may include logical functions which may be used by a UE for communicating with the access network via non-standardized access. For example, a 5G access network (5G AN) may include a non-3GPP interworking function (N3IWF) (e.g., responsible for routing messages outside the 5G AN), a trusted non-3GPP gateway function (TNGF) (e.g., an interface that may enable a UE to connect to the 5G AN over WLAN access), a trusted WLAN interworking function (TWIF) (e.g., providing interworking functionality that enables non-5G-capable over WLAN (N5CW) devices to access 5GC), and/or a wireline access gateway function (W-AGF) (e.g., provides termination of N2 and N3 interfaces to 5G AN for control—plane and user-plane respectively), etc. However, the geographical location(s) associated with these functions may not be correlated with the UE, where these functions may be deployed centrally in the network. Thus, when 3GPP access is not available, the 5G AN may not be able to achieve an accurate UE location to comply with regulations of certain countries or regions.

Aspects presented herein may enable the location of a UE accessing a network via non-standardized access (e.g., non-3GPP access) to be determined or estimated. Aspects presented herein may enable a network, such as a 5G core network or an IMS network, to be able to derive location information of a UE accessing the network via non-standardized access, where the location information may also enable the network to determine which public-safety answering point (PSAP) (which may also be referred to “public-safety access point”) serves the area in which the UE may be located. For example, if the UE initiates an emergency session, such as by calling for an emergency service (e.g., police department, fire department, ambulance, etc.) via the IMS (e.g., the VoWiFi), the network may route the emergency session to a correct or nearest PSAP. Thus, the PSAP may be able to obtain a more accurate or updated location information for the UE during or after the emergency session, which may also enable the network to comply with local regulations. For purposes of the present disclosure, a device, a function and/or an entity that is not based on 3GPP standards may be referred to as a “non-network connection entity,” which may include WLAN AP, Wi-Fi, and/or WiMax, etc.

In one aspect of the present disclosure, a network, such as a 5GC network or an IMS network, may be configured to maintain a mapping table between a non-network connection entity (e.g., a WLAN AP) accessed by a UE and the location information associated with the non-network connection entity, where the mapping table may be used by the network for deriving the UE location information. For example, when a UE connects to a network (e.g., connected to 5GC network, registered to the IMS, etc.) via a non-network connection entity (e.g., an WLAN AP), the UE may be configured to report an identifier (ID) associated with the non-network connection entity to the network, where the ID may be used for identifying or deriving a location associated with the non-network connection entity (e.g., based on the IP of the non-network connection entity, registered address of the non-network connection entity, the known location of the non-network connection entity, etc.).

For example, when a UE connects to a 5GC network or registers to an IMS network via a WLAN AP, the UE may report an ID associated with the WLAN AP (e.g., a WLAN access point name (APN) ID) to the 5GC/IMS network, where the WLAN AP ID may be associated with or used for identifying a location of the corresponding WLAN AP. The 5GC/IMS network may maintain a mapping table that records at least the WLAN AP ID reported by the UE, the location associated with the WLAN AP ID, and/or the age of the location information (e.g., the time in which the WLAN AP ID is reported by the UE), etc. The UE may be configured to report/update the WLAN APNID of the WLAN AP accessed by the UE at a configured periodicity and/or when requested by the network, such that the network may continue to update the WLAN APNID and location information in the mapping table for the UE to keep the mapping table up-to-date. Then, when the network receives a request to identify the UE's location, such as when the UE makes an emergency call, the network may be able to derive or estimate the UE's location based on the mapping table (e.g., based at in part on the location of the WLAN AP accessed by the UE). In other words, the 5GC/IMS network may trigger a location request to the UE in order to keep the location of APN accessed by the UE up-to-date, and the 5GC/IMS network may then derive the UE location information for emergency services from non-3GPP access based on the location of the APN.

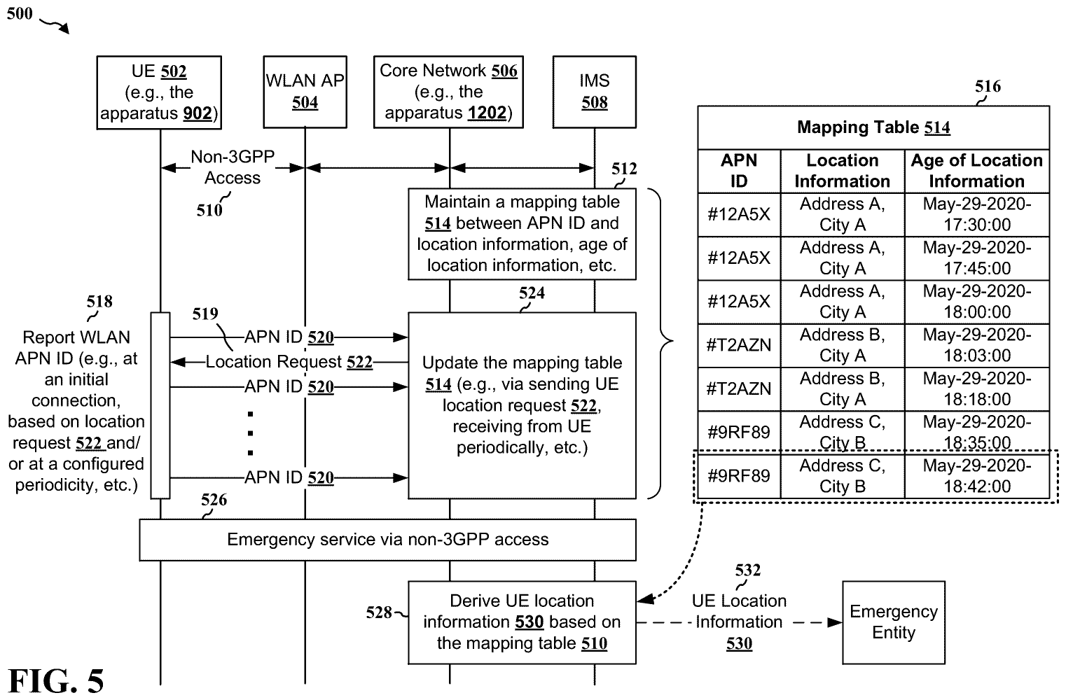

FIG. 5 is a communication flow 500 illustrating an example of a network determining a UE's location based on a location of a non-network connection entity in accordance with various aspects of the present disclosure. The numberings associated with the communication flow do not specify a particular temporal order and are merely used as references for the communication flow.

At 510, a UE 502 may establish a connection with a non-network connection entity 504 (e.g., a communication device that is not based on 3GPP standards, such as a WLAN AP), where the non-network connection entity 504 may provide the UE 502 with an access to a network 506 (e.g., a 5GC network) and/or an IMS 508 (e.g., an IMS network). In other words, the non-network connection entity 504 may provide a non-3GPP access to the UE 502, such as described in connection with FIG. 4.

At 512, the network 506 and/or the IMS 508 may maintain a mapping table 514 which may include an ID associated with the non-network connection entity 504 (e.g., an APN ID), a location information associated with the APN ID, and/or the age of the location information, etc., such as shown at 516. For example, an IMS or a 5GC node (e.g., a proxy-call session control function (P-CSCF), an LRF/GMLC, or an application server (AS)) may maintain the mapping table 514 between the APN ID (e.g., BSSID or LID) and the corresponding location information (e.g., Cell ID, geographical location information, etc.), the age of location information, etc. In some examples, the IMS or the 5GC node may update the location information of the APN ID via an access manager (e.g., OAM), or location information reported from the UE or the network.

At 518, the UE 502 may transmit an ID 520 associated with the non-network connection entity 504 to the network 506 and/or the IMS 508. In other words, the UE 502 may report to the network 506 and/or the IMS 508 the ID of the non-network connection entity to which the UE 502 is currently connected (and to which it may have been connected in the past). In one example, the UE 502 may be configured to transmit the ID 520 of the non-network connection entity 504 when the UE 502 connects to the network 506 and/or the IMS 508 via the non-network connection entity 504 (e.g., at an initial connection). Additionally, the UE 502 may be configured to transmit the ID 520 of the non-network connection entity 504 at a periodicity, e.g., every ten, fifteen, thirty minutes, etc., which may be configurable by the network 506 and/or the IMS 508. Additionally, the UE 502 may be configured to transmit the ID 520 when the UE 502 is requested by the network 506 and/or the IMS 508. For example, as shown at 519, the network 506 and/or the IMS 508 may transmit a location request 522 to the UE 502. After receiving the location request 522, the UE 502 may provide the ID 520 of the non-network connection entity 504 that the UE 502 is currently accessing and/or had accessed the network 506 and/or the IMS 508.

In one example, the ID 520 may be an WLAN APN ID that includes at least one of a service set identifier (SSID), a basic service set identifier (BSSID), or a line identifier (LID) associated with the non-network connection entity 504, where a location associated with the non-network connection entity 504 may be identified based at least in part on the SSID, the BSSID, and/or the LID, etc. In some examples, the BSSID may be a media access control (MAC) address/MAC ID. In other examples, the non-network connection entity 504 may be associated with an IP address, which may provide a location for the non-network connection entity 504. In another example, the non-network connection entity 504 may have a registered address and/or location. Thus, by identifying the ID of the non-network connection entity 504, a location associated with the non-network connection entity 504 may be determined.

In some examples, the SSID of an access point (AP) may be the same for several APs. However, the BSSID may be a MAC address (or MAC ID) of an AP, which may be globally unique based on IEEE 802.11, and the LID may be applied for trusted access of wireline access to 5GC. Thus, in some examples, the ID 520 (e.g., the identifier of WLAN APN) may be configured to include at least one of the BSSID and the LID.

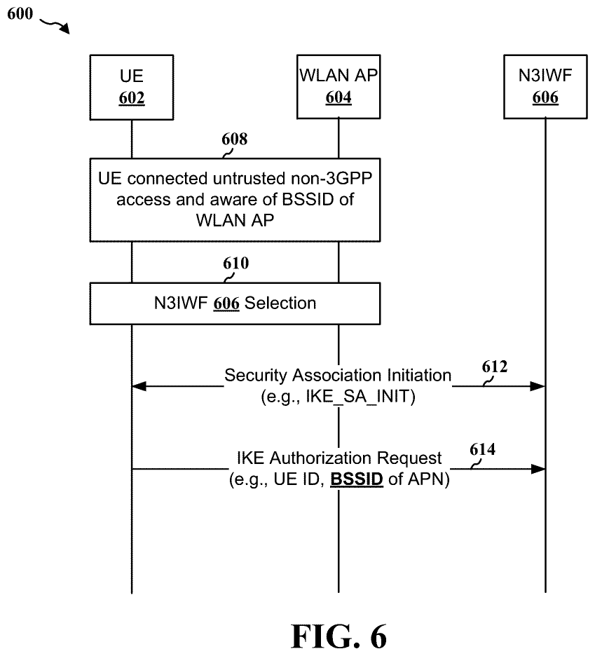

In one aspect of the present disclosure, a UE may report the APN information (e.g., the APN ID) at a protocol data unit (PDU) session establishment. FIG. 6 is a communication flow 600 illustrating an example of a UE reporting APN information in an untrusted non-3GPP access PDU session establishment in accordance with various aspects of the present disclosure.

At 608, a UE 602 (e.g., the UE 502) may connect to a WLAN AP 604 (e.g., the non-network connection entity 504) based on an untrusted non-3GPP access. After the UE connects to the WLAN AP 604, the UE 602 may become aware of a BSSID associated with the WLAN AP 604. In other words, the UE 602 may obtain the BSSID (e.g., MAC address/ID of an AP) when the UE 602 connects to the WLAN AP 604. In some examples, the UE 602 may connect to the WLAN AP 604 (e.g., an untrusted non-3GPP AN) with an authentication procedure, and the UE 602 may be assigned with an IP address. A non-3GPP authentication method may be used for the authentication procedure, which may include no authentication (e.g., in the case of a free WLAN), EAP with pre-shared key, username/password, etc. When the UE 602 decides to attach to the 5GC network, the UE 602 may select an N3IWF 606 (e.g., a non-3GPP interworking function that may route messages outside the 5G AN) in a 5G public land mobile network (PLMN), such as shown at 610.

At 612, the UE 602 may proceed with an establishment of an IPsec Security Association (SA) with the selected N3IWF 606 by initiating an Internet Key Exchange (IKE) initial exchange. Thus, subsequent IKE messages may be encrypted and integrity protected by using the established IKE SA.

At 614, the UE 602 may initiate an authorization (e.g., an IKE_AUTH) exchange with the selected N3IWF 606 by sending an authorization request message (e.g., an IKE_AUTH_REQ message) to the N3IWF 606. The authorization (e.g., AUTH) payload may not be included in the authorization request message, which may indicate that the authorization exchange may use extensible authentication protocol (EAP) signaling (e.g., EAP-5G signaling). In one example, the UE 602 may transmit/carry the BSSID of an APN (e.g., the APN ID 520 and additionally the UE ID) to the N3IWF 606 in the authorization request message before an IPsec tunnel.

In another aspect of the present disclosure, if a UE is connected to the network (e.g., 5GC network) via a trusted non-3GPP access, such as a trusted WLAN access network (TWAN), the TWAN may report a TWAN identifier which may include the BSSID and/or the LID to TNGF/TWIF. The TNGF and/or the TWIF may also report the user location information (include BSSID or LID) to Access and Mobility Management Function (AMF) via N2 signaling.

In another aspect of the present disclosure, a UE may report the APN information (e.g., the APN ID 520) based on IMS signaling. For example, if a UE is aware of APN information (e.g., BSSID of WLAN APN), the UE may send this information to P-CSCF in IMS signaling at IMS registration, IMS emergency registration, IMS session initiation, and/or short message service (SMS) over IP procedures. For example, the information may be carried in a parameter (e.g., an i-wlan-node-id parameter) of a P-Access-Network-Info header field.

Referring back to FIG. 5, at 524, after receiving the ID 520 from the UE and/or the non-network connection entity 504, such as described in connection with FIG. 6, the network 506 and/or the IMS 508 may update the mapping table 514. For example, based on the PLMN policy associated with the local regulations and/or the age of location information, the network 506 and/or the IMS 508 node may update the location information of a specific WLAN APN ID, such as shown at 516.

In some examples, when the network 506 and/or the IMS 508 detected the UE 502 connected to a specific APN ID and/or registered to the IMS 508, the network 506 and/or the IMS 508 may trigger a location request (e.g., the location request 522) (e.g., based on mobile terminated location requests (MT-LR) and/or network induced location request (NI-LR)) targeting the UE 502 via a policy control function (PCF) in 3GPP access. Then, the network 506 and/or the IMS 508 node may update the location information of the APN ID. In some examples, for trusted non-3GPP access and/or wireline access, an MNO may achieve/obtain the location information of the non-network connection entity 504 (e.g., the WLAN AP) via access manager (e.g., OAM) input. In such examples, the network 506 and/or the IMS 508 may skip sending the location request to the UE 502 for updating the AP location information.

At 526, the UE 502 that is connect to the non-network connection entity 504 (e.g., the WLAN AP, a non-3GPP access, etc.) may request emergency service to the network 506 and/or the IMS 508 (e.g., to establish an emergency session), such as by calling an emergency service (e.g., police department, fire department, ambulance, etc.) using the voice service via the IMS 508 (e.g., VoWiFi).

In one example (e.g., Option A), if the UE 502 has its location information (e.g., the UE 502 knows its location) available (e.g., via GNSS), the UE 502 may include the location information in the emergency service request to establish an emergency session (e.g., at 526). In another example (e.g., Option B), if 3GPP access is available, the network 506 and/or the IMS 508 may trigger a location request (e.g., the location request 522) of the UE via 3GPP access. In another example (e.g., Option C), if the UE location (e.g., location of the UE 502) is not available (e.g., Options A and B are not available), as shown at 528, the network 506 and/or the IMS 508 may derive the UE location 530 based on the received APNID (e.g., BSSID, and/or LID) by checking the stored mapping table 524 (e.g., based on the information collected at 512 and 524). For example, as shown at 516, the network 506 and/or the IMS 508 may derive the UE location 530 based on the location of the last non-network connection entity (e.g., the non-network connection entity 504) accessed by the UE 502. In another example, if the UE 502 and the network 506/IMS 508 support secure user plane location (SUPL) service, the UE location may be achieved/derived from SUPL server via a User Plane connection.

At 532, the network 506 and/or the IMS 508 may transmit the UE location information to an entity associated with the emergency service, and/or the network 506 and/or the IMS 508 may determine which PSAP serves the area in which the UE 502 may be located. For example, or the network 506 and/or the IMS 508 may route the emergency session established by the UE 502 to a correct or nearest PSAP. Thus, the PSAP may be able to obtain a more accurate or updated location information for the UE 502 during or after the emergency session, which may also enable the network 506 and/or the IMS 508 to comply with local regulation.

Aspects presented herein provide several methods to support UE location in emergence service via non-3GPP access, where an IMS, a 5GC and/or a SUPL server may be configured to maintain a mapping table between WLAN APN and location information to fulfill the regulatory specifications of emergency services via non-3GPP access. For example, a UE may report the APN ID (e.g., BSSID or LID) of the AP it accesses to the IMS, the 5GC, and/or the SUPL server via non-3GPP access. The IMS, the 5GC, and/or the SUPL server may also trigger location request process of UEs to keep the mapping table of each APN ID up-to-date. When an emergency service via non-3GPP access is triggered, the location information of the UE may be achieved via checking the mapping table, such as described in connection with FIGS. 5 and 6.

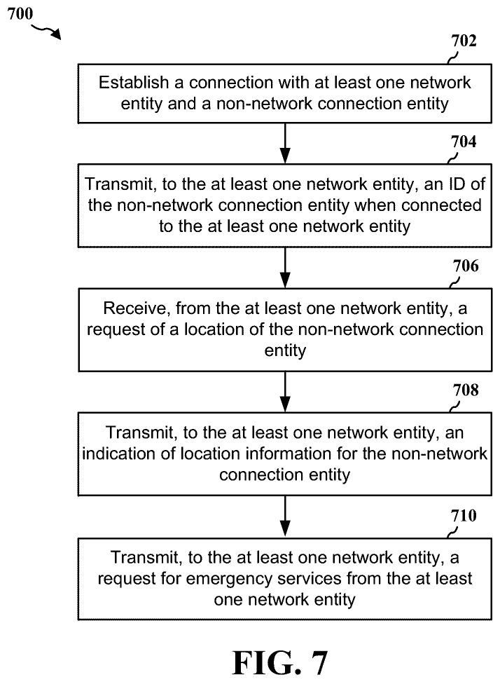

FIG. 7 is a flowchart 700 of a method of wireless communication. The method may be performed by a UE or a component of a UE (e.g., the UE 104, 350, 402, 502, 602; the apparatus 902; a processing system, which may include the memory 360 and which may be the entire UE 350 or a component of the UE 350, such as the TX processor 368, the RX processor 356, and/or the controller/processor 359). The method may enable the UE to indicate to a network (e.g., a bae station) an ID associated with a non-3GPP AP in which that UE is using for accessing the network, where the ID may be used for deriving the UE's approximate location.

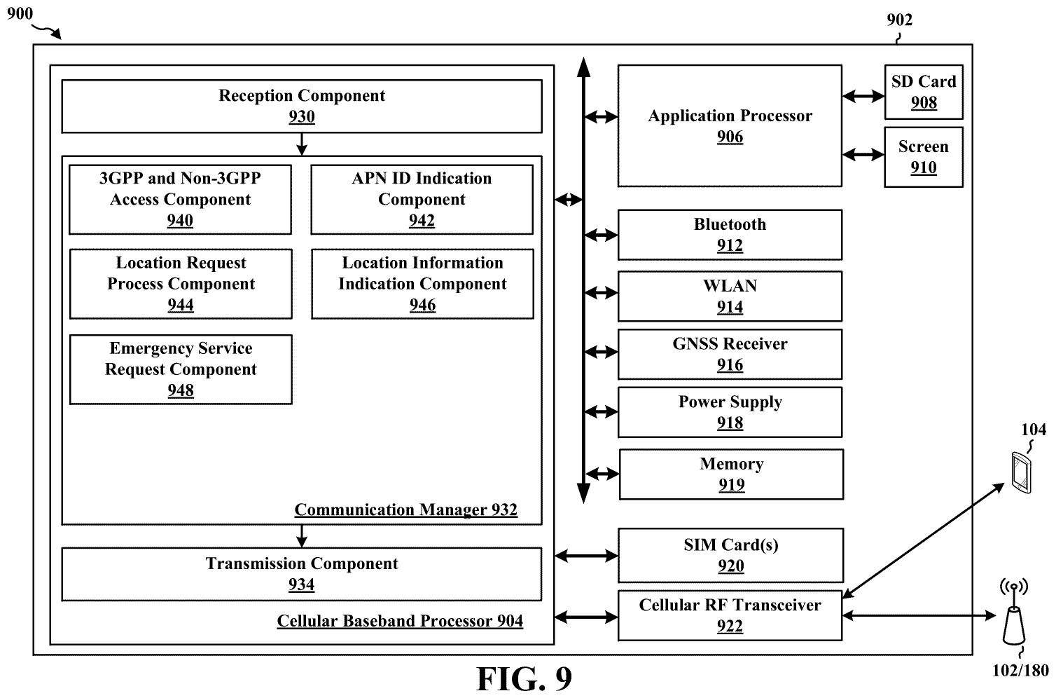

At 702, the UE may establish a connection with at least one network entity and a non-network connection entity, such as described in connection with FIGS. 4 to 6. For example, at 510, the UE 502 may establish a connection with a non-network connection entity 504 (e.g., a WLAN AP) and a network 506 (e.g., a 5GC network). The establishment of the connection may be performed by, e.g., the 3GPP and Non-3GPP access component 940, the reception component 930, and/or the transmission component 934 of the apparatus 902 in FIG. 9.

At 704, the UE may transmit, to the at least one network entity, an ID of the non-network connection entity when connected to the at least one network entity, such as described in connection with FIGS. 5 and 6. For example, at 518, the UE 502 may transmit an ID 520 of the non-network connection entity 504 to the network 506 and/or the IMS 508 when the UE 502 is connected to the network 506 and/or the IMS 508. The transmission of the ID may be performed by, e.g., the APN ID indication component 942 and/or the transmission component 934 of the apparatus 902 in FIG. 9.

In one example, the at least one network entity may include at least one of a 5GC network or an IMS. In such an example, the 5GC network or the IMS may be associated with at least one of a P-CSCF, a GMLC, an LRF, or an AS. In such an example, the ID of the non-network connection entity may be transmitted to the P-CSCF in IMS signaling at IMS registration, IMS emergency registration, IMS session initiation, or SMS over IP procedures.

In another example, the non-network connection entity provides the UE with a non-3GPP access, and the ID of the non-network connection entity may be transmitted to a N3IWF when the UE establishes a PDU session with the N3IWF. In such an example, the ID may be transmitted in an IKE authorization request message associated with the PDU session establishment

In another example, the non-network connection entity may be a WLAN AP. In such an example, the ID may be an APN or an APN ID that is associated with the WLAN AP. In such an example, the APN ID may include at least one of an SSID, a BSSID, or a LID.

At 706, the UE may receive, from the at least one network entity, a request for a location of the non-network connection entity, such as described in connection with FIG. 5. For example, at 519, the UE 502 may receive a location request 522 from the network 506 and/or the IMS 508 associated with a location (e.g., the ID) of the non-network connection entity. The reception of the request may be performed by, e.g., the location request process component 944 and/or the reception component 930 of the apparatus 902 in FIG. 9.

At 708, the UE may transmit, to the at least one network entity, an indication of location information for the non-network connection entity, such as described in connection with FIG. 5. For example, at 518, the UE 502 may transmit the ID 520 of the non-network connection entity to the network 506 and/or the IMS 508. The transmission of the indication may be performed by, e.g., the APN ID indication component 942, the location information indication component 946, and/or the transmission component 934 of the apparatus 902 in FIG. 9.

At 710, the UE may transmit, to the at least one network entity, a request for an emergency service, such as described in connection with FIG. 5. For example, at 526, the UE 502 may request for an emergency service via non-3GPP access. The transmission of the request for emergency may be performed by, e.g., the emergency service request component 948 and/or the transmission component 934 of the apparatus 902 in FIG. 9.

In one example, the request may include a location information of the UE. In such an example, the location information the location information may be determined, at least in part, using a GNSS receiver.

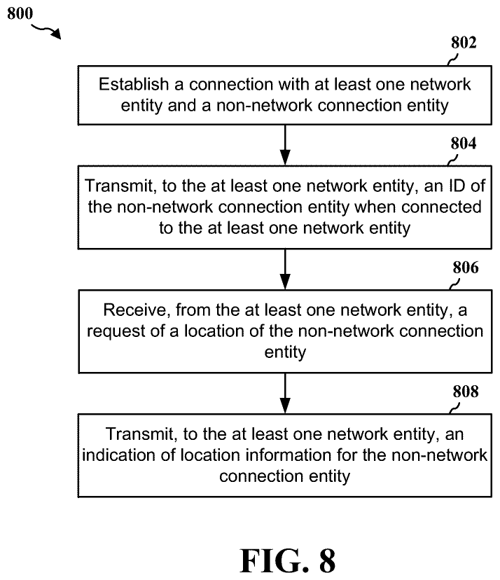

FIG. 8 is a flowchart 800 of a method of wireless communication. The method may be performed by a UE or a component of a UE (e.g., the UE 104, 350, 402, 502, 602; the apparatus 902; a processing system, which may include the memory 360 and which may be the entire UE 350 or a component of the UE 350, such as the TX processor 368, the RX processor 356, and/or the controller/processor 359). The method may enable the UE to indicate to a network (e.g., a bae station) an ID associated with a non-3GPP AP in which that UE is using for accessing the network, where the ID may be used for deriving the UE's approximate location.

At 802, the UE may establish a connection with at least one network entity and a non-network connection entity, such as described in connection with FIGS. 4 to 6. For example, at 510, the UE 502 may establish a connection with a non-network connection entity 504 (e.g., a WLAN AP) and a network 506 (e.g., a 5GC network). The establishment of the connection may be performed by, e.g., the 3GPP and Non-3GPP access component 940, the reception component 930, and/or the transmission component 934 of the apparatus 902 in FIG. 9.

At 804, the UE may transmit, to the at least one network entity, an ID of the non-network connection entity when connected to the at least one network entity, such as described in connection with FIGS. 5 and 6. For example, at 518, the UE 502 may transmit an ID 520 of the non-network connection entity 504 to the network 506 and/or the IMS 508 when the UE 502 is connected to the network 506 and/or the IMS 508. The transmission of the ID may be performed by, e.g., the APN ID indication component 942 and/or the transmission component 934 of the apparatus 902 in FIG. 9.

In one example, the at least one network entity may include at least one of a 5GC network or an IMS. In such an example, the 5GC network or the IMS may be associated with at least one of a P-CSCF, a GMLC, an LRF, or an AS. In such an example, the ID of the non-network connection entity may be transmitted to the P-CSCF in IMS signaling at IMS registration, IMS emergency registration, IMS session initiation, or SMS over IP procedures.

In another example, the non-network connection entity provides the UE with a non-3GPP access, and the ID of the non-network connection entity may be transmitted to a N3IWF when the UE establishes a PDU session with the N3IWF. In such an example, the ID may be transmitted in an IKE authorization request message associated with the PDU session establishment

In another example, the non-network connection entity may be a WLAN AP. In such an example, the ID may be an APN or an APN ID that is associated with the WLAN AP. In such an example, the APN ID may include at least one of an SSID, a BSSID, or a LID.

At 806, the UE may receive, from the at least one network entity, a request for a location of the non-network connection entity, such as described in connection with FIG. 5. For example, at 519, the UE 502 may receive a location request 522 from the network 506 and/or the IMS 508 associated with a location (e.g., the ID) of the non-network connection entity. The reception of the request may be performed by, e.g., the location request process component 944 and/or the reception component 930 of the apparatus 902 in FIG. 9.

At 808, the UE may transmit, to the at least one network entity, an indication of location information for the non-network connection entity, such as described in connection with FIG. 5. For example, at 518, the UE 502 may transmit the ID 520 of the non-network connection entity to the network 506 and/or the IMS 508. The transmission of the indication may be performed by, e.g., the APN ID indication component 942, the location information indication component 946, and/or the transmission component 934 of the apparatus 902 in FIG. 9.

In one example, the UE may transmit, to the at least one network entity, a request for an emergency service from the at least one network entity, such as described in connection with FIG. 5. For example, at 526, the UE 502 may request for an emergency service via non-3GPP access. The transmission of the request for emergency may be performed by, e.g., the emergency service request component 948 and/or the transmission component 934 of the apparatus 902 in FIG. 9. In such an example, the request may include a location information of the UE. In such an example, the location information may be determined, at least in part, using a GNSS receive (e.g., the GNSS receiver module 916).

FIG. 9 is a diagram 900 illustrating an example of a hardware implementation for an apparatus 902. The apparatus 902 may be a UE, a component of a UE, or may implement UE functionality. In some aspects, the apparatus 902 may include a cellular baseband processor 904 (also referred to as a modem) coupled to a cellular RF transceiver 922. In some aspects, the apparatus 902 may further include one or more subscriber identity modules (SIM) cards 920, an application processor 906 coupled to a secure digital (SD) card 908 and a screen 910, a Bluetooth module 912, a wireless local area network (WLAN) module 914, a GNSS receiver module 916, a power supply 918, or a memory 919. The cellular baseband processor 904 communicates through the cellular RF transceiver 922 with the UE 104 and/or BS 102/180. The cellular baseband processor 904 may include a computer-readable medium/memory. The computer-readable medium/memory may be non-transitory. The cellular baseband processor 904 is responsible for general processing, including the execution of software stored on the computer-readable medium/memory. The software, when executed by the cellular baseband processor 904, causes the cellular baseband processor 904 to perform the various functions described supra. The computer-readable medium/memory may also be used for storing data that is manipulated by the cellular baseband processor 904 when executing software. The cellular baseband processor 904 further includes a reception component 930, a communication manager 932, and a transmission component 934. The communication manager 932 includes the one or more illustrated components. The components within the communication manager 932 may be stored in the computer-readable medium/memory and/or configured as hardware within the cellular baseband processor 904. The cellular baseband processor 904 may be a component of the UE 350 and may include the memory 360 and/or at least one of the TX processor 368, the RX processor 356, and the controller/processor 359. In one configuration, the apparatus 902 may be a modem chip and include just the baseband processor 904, and in another configuration, the apparatus 902 may be the entire UE (e.g., see 350 of FIG. 3) and include the additional modules of the apparatus 902.

The communication manager 932 includes a 3GPP and non-3GPP access component 940 that is configured to establish a connection with at least one network entity and a non-network connection entity, e.g., as described in connection with 702 of FIGS. 7 and/or 802 of FIG. 8. The communication manager 932 further includes an APN ID indication component 942 that is configured to transmit, to the at least one network entity, an ID of the non-network connection entity when connected to the at least one network entity, e.g., as described in connection with 704 of FIGS. 7 and/or 804 of FIG. 8. The communication manager 932 further includes a location request process component 944 that is configured to receive, from the at least one network entity, a request for a location of the non-network connection entity, e.g., as described in connection with 706 of FIGS. 7 and/or 806 of FIG. 8. The communication manager 932 further includes a location information indication component 946 that is configured to transmit, to the at least one network entity, an indication of location information for the non-network connection entity, e.g., as described in connection with 708 of FIGS. 7 and/or 808 of FIG. 8. The communication manager 932 further includes an emergency service request component 948 that is configured to transmit, to the at least one network entity, a request for an emergency service from the at least one network entity, e.g., as described in connection with 710 of FIG. 7 of FIG. 8.

The apparatus may include additional components that perform each of the blocks of the algorithm in the flowcharts of FIGS. 7 and 8. As such, each block in the flowcharts of FIGS. 7 and 8 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 902 may include a variety of components configured for various functions. In one configuration, the apparatus 902, and in particular the cellular baseband processor 904, includes means for establishing a connection with at least one network entity and a non-network connection entity (e.g., the 3GPP and Non-3GPP access component 940, the reception component 930, and/or the transmission component 934). The apparatus 902 includes means for transmitting, to the at least one network entity, an ID of the non-network connection entity when connected to the at least one network entity (e.g., the APN ID indication component 942 and/or the transmission component 934). The apparatus 902 includes means for receiving, from the at least one network entity, a request for a location of the non-network connection entity (e.g., the location request process component 944 and/or the reception component 930). The apparatus 902 includes means for transmitting, to the at least one network entity, an indication of location information for the non-network connection entity (e.g., the location information indication component 946 and/or the transmission component 934). The apparatus 902 includes means for transmitting, to the at least one network entity, a request for an emergency service from the at least one network entity (e.g., the emergency service request component 948 and/or the transmission component 934).

In one configuration, the at least one network entity may include at least one of a 5GC network or an IMS. In such a configuration, the 5GC network or the IMS may be associated with at least one of a P-CSCF, a GMLC, an LRF, or an AS. In such a configuration, the ID of the non-network connection entity may be transmitted to the P-CSCF in IMS signaling at IMS registration, IMS emergency registration, IMS session initiation, or SMS over IP procedures.

In another configuration, the non-network connection entity provides the UE with a non-3GPP access, and the ID of the non-network connection entity may be transmitted to a N3IWF when the UE establishes a PDU session with the N3IWF. In such a configuration, the ID may be transmitted in an IKE authorization request message associated with the PDU session establishment

In another configuration, the non-network connection entity may be a WLAN AP. In such a configuration, the ID may be an APN or an APN ID that is associated with the WLAN AP. In such a configuration, the APN ID may include at least one of an SSID, a BSSID, or a LID.

In another configuration, the request may include a location information of the UE. In such a configuration, the apparatus 902 further comprises a GNSS receiver, where the location information may be determined, at least in part, using the GNSS receiver.

The means may be one or more of the components of the apparatus 902 configured to perform the functions recited by the means. As described supra, the apparatus 902 may include the TX Processor 368, the RX Processor 356, and the controller/processor 359. As such, in one configuration, the means may be the TX Processor 368, the RX Processor 356, and the controller/processor 359 configured to perform the functions recited by the means.

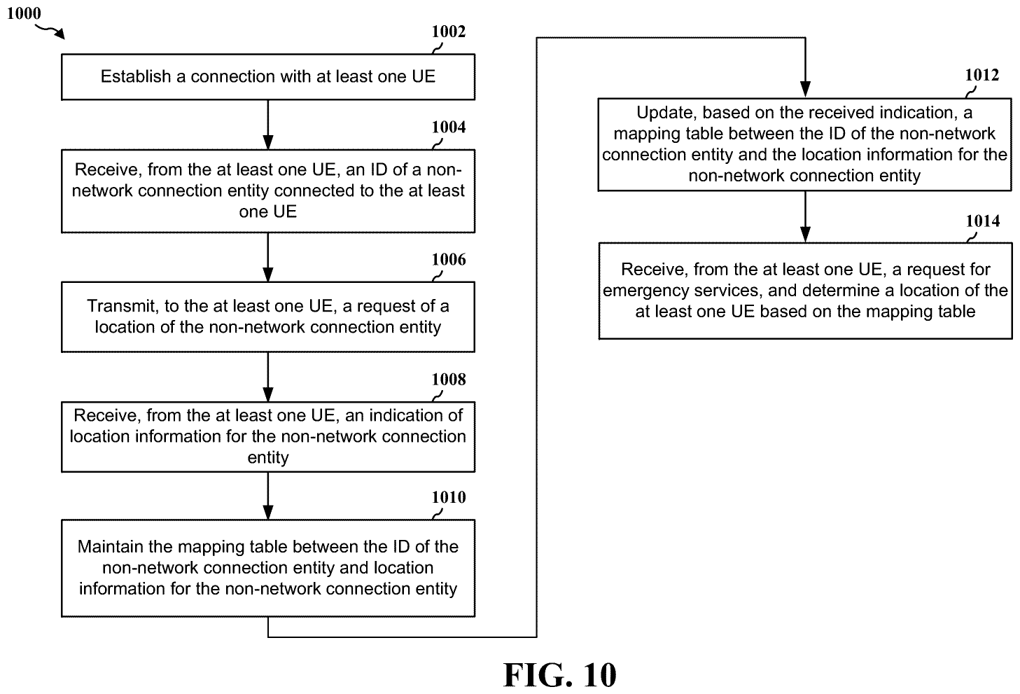

FIG. 10 is a flowchart 1000 of a method of wireless communication. The method may be performed by a network entity or a component of a network entity (e.g., the base station 102, 180, 310; the network 404, 506; the IMS 508; the apparatus 1202; a processing system, which may include the memory 376 and which may be the entire base station 310 or a component of the base station 310, such as the TX processor 316 the RX processor 370, and/or the controller/processor 375). The method may enable the network entity to maintain a mapping table between AP(s) accessed by a UE and location information associated with the AP(s), where the base station may be able to derive or estimate the UE's location based on the mapping table if the UE is accessing the base station via a non-3GPP access.

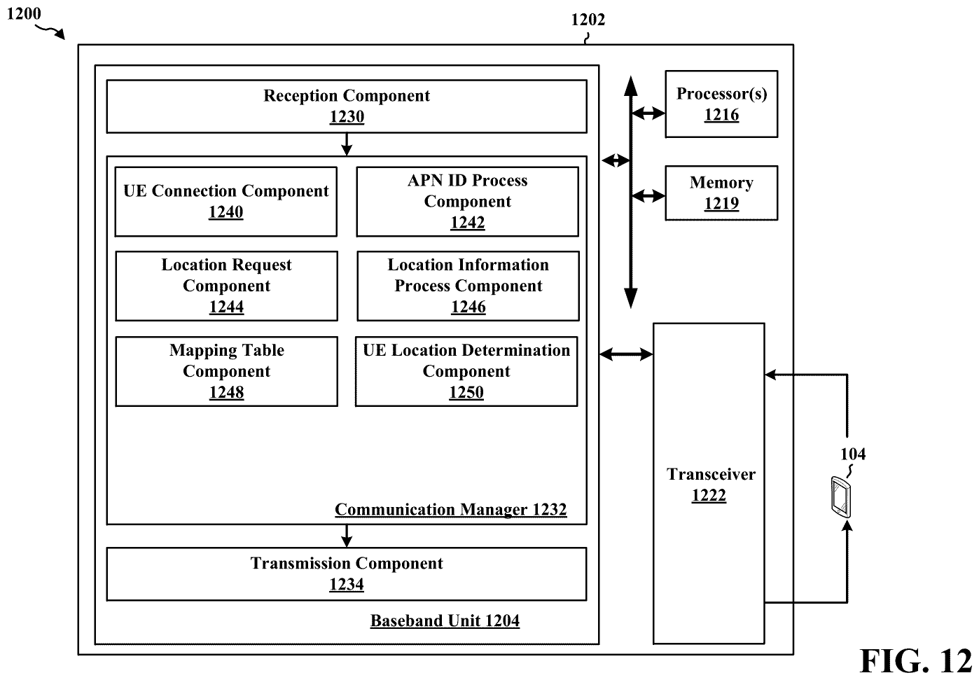

At 1002, the network entity may establish a connection with at least one UE, such as described in connection with FIG. 5. For example, at 510, the network 506 and/or the IMS 508 may establish a connection with the UE 502. The establishment of the connection may be performed by, e.g., the UE connection component 1240, the reception component 1230 and/or the transmission component 1234 of the apparatus 1202 in FIG. 12.

At 1004, the network entity may receive, from the at least one UE, an ID of a non-network connection entity connected to the at least one UE, such as described in connection with FIG. 5. For example, at 518, the network 506 and/or the IMS 508 may receive, from the UE 502, an ID 520 of a non-network connection entity 504 connected to the UE 502. The reception of the ID may be performed by, e.g., the APN ID process component 1242 and/or the reception component 1230 of the apparatus 1202 in FIG. 12.

In one example, the network entity may include at least one of a 5GC network or an IMS. In such an example, the 5GC network or the IMS may be associated with at least one of a P-CSCF, a GMLC, an LRF, or an AS. In such an example, the ID of the non-network connection entity may be received via the P-CSCF in IMS signaling at IMS registration, IMS emergency registration, IMS session initiation, or short SMS over IP procedures.

In another example, the non-network connection entity may provide the UE with a non-3GPP access, and the ID of the non-network connection entity may be received via a N3IWF when the UE establishes a PDU session via the N3IWF. In such an example, the ID may be received in an IKE authorization request message associated with the PDU session establishment.

In another example, the ID of the non-network connection entity may be received from a TWAN in a TWAN identifier.

In another example, the non-network connection entity may be a WLAN AP. In such an example, the ID may be an APN or an APN ID that is associated with the WLAN AP. In such an example, the APN ID may include at least one of an SSID, a BSSID, or a LID.

At 1006, the network entity may transmit, to the at least one UE, a request for a location of the non-network connection entity, such as described in connection with FIG. 5. For example, at 519, the network 506 and/or the IMS 508 may transmit, to the UE 502, a location request 522 of the non-network connection entity 504. The transmission of the request may be performed by, e.g., the location request component 1244 and/or the transmission component 1234 of the apparatus 1202 in FIG. 12.

At 1008, the network entity may receive, from the at least one UE, an indication of location information for the non-network connection entity, such as described in connection with FIG. 5. For example, at 518, the network 506 and/or the IMS 508 may receive, from the UE 502, an indication of location information (e.g., the ID 520) for the non-network connection entity 504. The reception of the indication may be performed by, e.g., the location information process component 1246, the APN ID process component 1242, and/or the reception component 1230 of the apparatus 1202 in FIG. 12.

At 1010, the network entity may maintain the mapping table between the ID of the non-network connection entity and location information for the non-network connection entity, such as described in connection with FIG. 5. For example, at 512, the network 506 and/or the IMS 508 may maintain the mapping table 514 between the ID of the non-network connection entity 504 and location information for the non-network connection entity 504. The maintaining of the mapping table may be performed by, e.g., the mapping table component 1248 of the apparatus 1202 in FIG. 12.

At 1012, the network entity may update, based on the received indication, a mapping table between the ID of the non-network connection entity and the location information for the non-network connection entity, such as described in connection with FIG. 5. For example, at 524, the network 506 and/or the IMS 508 may update the mapping table 514 between the ID of the non-network connection entity 504 and the location information for the non-network connection entity 504. The update of the mapping table may be performed by, e.g., the mapping table component 1248 of the apparatus 1202 in FIG. 12.

In one example, the mapping table may include at least the ID, the location information for the non-network connection entity, and age of the location information

At 1014, the network entity may receive, from the at least one UE, a request for an emergency service, and may determine a location of the at least one UE based on the mapping table, such as described in connection with FIG. 5. For example, at 526, the network 506 and/or the IMS 508 may receive, from the UE 502, a request for an emergency service (e.g., via non-3GPP access), and at 528, the network 506 and/or the IMS 508 may determine the location of the UE 502 based on the mapping table 514. The reception of the request and/or the determination of the UE location may be performed by, e.g., the UE location determination component 1250 and/or the reception component 1230 of the apparatus 1202 in FIG. 12. In one example, the network entity may check and output the location of the UE that connected to the non-network connection entity, when emergency service is triggered and no other method of location of the at least one UE is available.

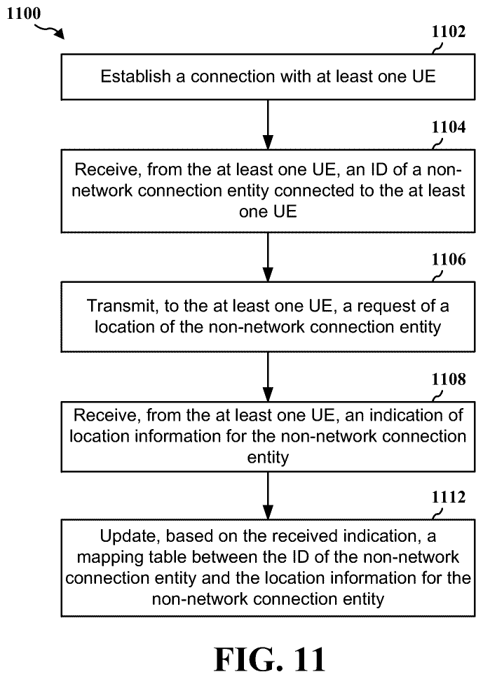

FIG. 11 is a flowchart 1100 of a method of wireless communication. The method may be performed by a network entity or a component of a network entity (e.g., the base station 102, 180, 310; the network 404, 506; the IMS 508; the apparatus 1202; a processing system, which may include the memory 376 and which may be the entire base station 310 or a component of the base station 310, such as the TX processor 316 the RX processor 370, and/or the controller/processor 375). The method may enable the network entity to maintain a mapping table between AP(s) accessed by a UE and location information associated with the AP(s), where the base station may be able to derive or estimate the UE's location based on the mapping table if the UE is accessing the base station via a non-3GPP access.

At 1102, the network entity may establish a connection with at least one UE, such as described in connection with FIG. 5. For example, at 510, the network 506 and/or the IMS 508 may establish a connection with the UE 502. The establishment of the connection may be performed by, e.g., the UE connection component 1240, the reception component 1230 and/or the transmission component 1234 of the apparatus 1202 in FIG. 12.

At 1104, the network entity may receive, from the at least one UE, an ID of a non-network connection entity connected to the at least one UE, such as described in connection with FIG. 5. For example, at 518, the network 506 and/or the IMS 508 may receive, from the UE 502, an ID 520 of a non-network connection entity 504 connected to the UE 502. The reception of the ID may be performed by, e.g., the APN ID process component 1242 and/or the reception component 1230 of the apparatus 1202 in FIG. 12.

In one example, the network entity may include at least one of a 5GC network or an IMS. In such an example, the 5GC network or the IMS may be associated with at least one of a P-CSCF, a GMLC, an LRF, or an AS. In such an example, the ID of the non-network connection entity may be received via the P-CSCF in IMS signaling at IMS registration, IMS emergency registration, IMS session initiation, or short SMS over IP procedures

In another example, the non-network connection entity may provide the UE with a non-3GPP access, and the ID of the non-network connection entity may be received via a N3IWF when the UE establishes a PDU session via the N3IWF. In such an example, the ID may be received in an IKE authorization request message associated with the PDU session establishment.

In another example, the ID of the non-network connection entity may be received from a TWAN in a TWAN identifier.

In another example, the non-network connection entity may be a WLAN AP. In such an example, the ID may be an APN or an APN ID that is associated with the WLAN AP. In such an example, the APN ID may include at least one of an SSID, a BSSID, or a LID.

At 1106, the network entity may transmit, to the at least one UE, a request for a location of the non-network connection entity, such as described in connection with FIG. 5. For example, at 519, the network 506 and/or the IMS 508 may transmit, to the UE 502, a location request 522 of the non-network connection entity 504. The transmission of the request may be performed by, e.g., the location request component 1244 and/or the transmission component 1234 of the apparatus 1202 in FIG. 12.

At 1108, the network entity may receive, from the at least one UE, an indication of location information for the non-network connection entity, such as described in connection with FIG. 5. For example, at 518, the network 506 and/or the IMS 508 may receive, from the UE 502, an indication of location information (e.g., the ID 520) for the non-network connection entity 504. The reception of the indication may be performed by, e.g., the location information process component 1246, the APN ID process component 1242, and/or the reception component 1230 of the apparatus 1202 in FIG. 12.

In one example, the network entity may maintain the mapping table between the ID of the non-network connection entity and location information for the non-network connection entity, such as described in connection with FIG. 5. For example, at 512, the network 506 and/or the IMS 508 may maintain the mapping table 514 between the ID of the non-network connection entity 504 and location information for the non-network connection entity 504. The maintaining of the mapping table may be performed by, e.g., the mapping table component 1248 of the apparatus 1202 in FIG. 12.

At 1112, the network entity may update, based on the received indication, a mapping table between the ID of the non-network connection entity and the location information for the non-network connection entity, such as described in connection with FIG. 5. For example, at 524, the network 506 and/or the IMS 508 may update the mapping table 514 between the ID of the non-network connection entity 504 and the location information for the non-network connection entity 504. The update of the mapping table may be performed by, e.g., the mapping table component 1248 of the apparatus 1202 in FIG. 12.

In one example, the mapping table may include at least the ID, the location information for the non-network connection entity, and age of the location information

The network entity may also receive, from the at least one UE, a request for an emergency service, and determine a location of the at least one UE based on the mapping table, such as described in connection with FIG. 5. For example, at 526, the network 506 and/or the IMS 508 may receive, from the UE 502, a request for an emergency service (e.g., via non-3GPP access), and at 528, the network 506 and/or the IMS 508 may determine the location of the UE 502 based on the mapping table 514. The reception of the request and/or the determination of the UE location may be performed by, e.g., the UE location determination component 1250 and/or the reception component 1230 of the apparatus 1202 in FIG. 12. In one example, the network entity may check and output the location of the UE that connected to the non-network connection entity, when the emergency service is triggered and no other method of location of the at least one UE is available.

FIG. 12 is a diagram 1200 illustrating an example of a hardware implementation for an apparatus 1202. The apparatus 1202 may be a network entity or a base station associated with the network entity, a component of a base station/network entity, or may implement base station/network entity functionality. In some aspects, the apparatus 1202 may include a baseband unit 1204. The baseband unit 1204 may communicate through a transceiver 1222 (e.g., a cellular RF transceiver) with the UE 104. In some aspects, the apparatus 1202 may further include one or more processors 1216 and a memory 1219. For example, the baseband unit 1204 may include a computer-readable medium/memory that is coupled to the one or more processors 1216 and/or the transceiver 1222. The baseband unit 1204 is responsible for general processing, including the execution of software stored on the computer-readable medium/memory. The software, when executed by the baseband unit 1204, causes the baseband unit 1204 to perform the various functions described supra. The computer-readable medium/memory may also be used for storing data that is manipulated by the baseband unit 1204 when executing software. The baseband unit 1204 further includes a reception component 1230, a communication manager 1232, and a transmission component 1234. The communication manager 1232 includes the one or more illustrated components. The components within the communication manager 1232 may be stored in the computer-readable medium/memory and/or configured as hardware within the baseband unit 1204. The baseband unit 1204 may be a component of the base station 310 and may include the memory 376 and/or at least one of the TX processor 316, the RX processor 370, and the controller/processor 375.

The communication manager 1232 includes a UE connection component 1240 that establishes a connection with at least one UE, e.g., as described in connection with 1002 of FIGS. 10 and/or 1102 of FIG. 11. The communication manager 1232 includes an APN ID process component 1242 that receives, from the at least one UE, an ID of a non-network connection entity connected to the at least one UE, e.g., as described in connection with 1004 of FIGS. 10 and/or 1104 of FIG. 11. The communication manager 1232 further includes a location request component 1244 that transmits, to the at least one UE, a request for a location of the non-network connection entity, e.g., as described in connection with 1006 of FIGS. 10 and/or 1106 of FIG. 11. The communication manager 1232 further includes a location information process component 1246 that receives, from the at least one UE, an indication of location information for the non-network connection entity, e.g., as described in connection with 1008 of FIGS. 10 and/or 1108 of FIG. 11. The communication manager 1232 further includes a mapping table component 1248 that updates, based on the received indication, a mapping table between the ID of the non-network connection entity and the location information for the non-network connection entity, and/or that maintains the mapping table between the ID of the non-network connection entity and location information for the non-network connection entity, e.g., as described in connection with 1010, 1012 of FIGS. 10 and/or 1112 of FIG. 11. The communication manager 1232 further includes a UE location determination component 1250 that determines a location of the at least one UE based on the mapping table, e.g., as described in connection with 1014 of FIG. 10.

The apparatus may include additional components that perform each of the blocks of the algorithm in the flowcharts of FIGS. 10 and 11. As such, each block in the flowcharts of FIGS. 10 and 11 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 1202 may include a variety of components configured for various functions. In one configuration, the apparatus 1202, and in particular the baseband unit 1204, includes means for establishing a connection with at least one UE (e.g., the UE connection component 1240, the reception component 1230 and/or the transmission component 1234). The apparatus 1202 includes means for receiving, from the at least one UE, an ID of a non-network connection entity connected to the at least one UE (e.g., the APN ID process component 1242 and/or the reception component 1230). The apparatus 1202 includes means for transmitting, to the at least one UE, a request for a location of the non-network connection entity (e.g., the location request component 1244 and/or the transmission component 1234). The apparatus 1202 includes means for receiving, from the at least one UE, an indication of location information for the non-network connection entity (e.g., the location information process component 1246, the APN ID process component 1242, and/or the reception component 1230). The apparatus 1202 includes means for updating, based on the received indication, a mapping table between the ID of the non-network connection entity and the location information for the non-network connection entity (e.g., the mapping table component 1248). The apparatus 1202 includes means for maintaining the mapping table between the ID of the non-network connection entity and location information for the non-network connection entity (e.g., the mapping table component 1248). The apparatus 1202 includes means for receiving, from the at least one UE, a request for an emergency service, and means for determining a location of the at least one UE based on the mapping table (e.g., the UE location determination component 1250 and/or the reception component 1230).

In one configuration, the network entity may include at least one of a 5GC network or an IMS. In such a configuration, the 5GC network or the IMS may be associated with at least one of a P-CSCF, a GMLC, an LRF, or an AS. In such a configuration, the ID of the non-network connection entity may be received via the P-CSCF in IMS signaling at IMS registration, IMS emergency registration, IMS session initiation, or short SMS over IP procedures

In another configuration, the non-network connection entity may provide the UE with a non-3GPP access, and the ID of the non-network connection entity may be received via a N3IWF when the UE establishes a PDU session via the N3IWF. In such a configuration, the ID may be received in an IKE authorization request message associated with the PDU session establishment.

In another configuration, the ID of the non-network connection entity may be received from a TWAN in a TWAN identifier.

In another configuration, the non-network connection entity may be a WLAN AP. In such a configuration, the ID may be an APN or an APN ID that is associated with the WLAN AP. In such a configuration, the APN ID may include at least one of an SSID, a BSSID, or a LID.

In one configuration, the mapping table may include at least the ID, the location information for the non-network connection entity, and age of the location information

The means may be one or more of the components of the apparatus 1202 configured to perform the functions recited by the means. As described supra, the apparatus 1202 may include the TX Processor 316, the RX Processor 370, and the controller/processor 375. As such, in one configuration, the means may be the TX Processor 316, the RX Processor 370, and the controller/processor 375 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

The following aspects are illustrative only and may be combined with other aspects or teachings described herein, without limitation.
Aspect 1 is an apparatus for wireless communication including at least one processor coupled to a memory and configured to establish a connection with at least one network entity and a non-network connection entity; transmit, to the at least one network entity, an ID of the non-network connection entity when connected to the at least one network entity; receive, from the at least one network entity, a request for a location of the non-network connection entity; and transmit, to the at least one network entity, an indication of location information for the non-network connection entity.
Aspect 2 is the apparatus of aspect 1, further including a transceiver coupled to the at least one processor.
Aspect 3 is the apparatus of any of aspects 1 and 2, where the at least one network entity includes at least one of a 5GC network or an IMS.
Aspect 4 is the apparatus of any of aspects 1 to 3, where the 5GC network or the IMS is associated with at least one of a P-CSCF, a GMLC, an LRF, or an AS.
Aspect 5 is the apparatus of any of aspects 1 to 4, where the ID of the non-network connection entity is transmitted to the P-CSCF in IMS signaling at IMS registration, IMS emergency registration, IMS session initiation, or SMS over IP procedures.
Aspect 6 is the apparatus of any of aspects 1 to 5, where the non-network connection entity is a WLAN AP.
Aspect 7 is the apparatus of any of aspects 1 to 6, where the ID is an APN or an APN ID that is associated with the WLAN AP.
Aspect 8 is the apparatus of any of aspects 1 to 7, where the APN ID includes at least one of an SSID, a BSSID, or a LID.
Aspect 9 is the apparatus of any of aspects 1 to 8, where the non-network connection entity provides the UE with a non-3GPP access, and where the ID of the non-network connection entity is transmitted to a N3IWF when the UE establishes a PDU session with the N3IWF.
Aspect 10 is the apparatus of any of aspects 1 to 9, where the ID is transmitted in an IKE authorization request message associated with the PDU session establishment.
Aspect 11 is the apparatus of any of aspects 1 to 10, where the processor is further configured to: transmit, to the at least one network entity, a request for an emergency service.
Aspect 12 is the apparatus of any of aspects 1 to 11, where the request for the emergency service includes a location information of the UE.
Aspect 13 is the apparatus of any of aspects 1 to 12, further comprising a GNSS receiver, where the location information is determined, at least in part, using the GNSS receiver.
Aspect 14 is a method of wireless communication for implementing any of aspects 1 to 13.
Aspect 15 is an apparatus for wireless communication including means for implementing any of aspects 1 to 13.
Aspect 16 is a computer-readable medium storing computer executable code, where the code when executed by a processor causes the processor to implement any of aspects 1 to 13.
Aspect 17 is an apparatus for wireless communication including at least one processor coupled to a memory and configured to establish a connection with at least one UE; receive, from the at least one UE, an ID of a non-network connection entity connected to the at least one UE; transmit, to the at least one UE, a request for a location of the non-network connection entity; receive, from the at least one UE, an indication of location information for the non-network connection entity; and update, based on the received indication, a mapping table between the ID of the non-network connection entity and the location information for the non-network connection entity.
Aspect 18 is the apparatus of aspect 17, further including a transceiver coupled to the at least one processor.
Aspect 19 is the apparatus of any of aspects 17 and 18, where the processor is further configured to: maintain the mapping table between the ID of the non-network connection entity and location information for the non-network connection entity.
Aspect 20 is the apparatus of any of aspects 17 to 19, where a location associated with the non-network connection entity is determined based at least in part on the ID of the non-network connection entity.
Aspect 21 is the apparatus of any of aspects 17 to 20, where the mapping table includes at least the ID, the location information for the non-network connection entity, and an age of the location information.
Aspect 22 is the apparatus of any of aspects 17 to 21, where the processor is further configured to: receive, from the at least one UE, a request for an emergency service; and determine a location of the at least one UE based on the mapping table.
Aspect 23 is the apparatus of any of aspects 17 to 22, where the processor is further configured to output the location of the at least one UE that connected to the non-network connection entity, when the emergency service is triggered, and no other method of location of the at least one UE is available.
Aspect 24 is the apparatus of any of aspects 17 to 23, where the processor is further configured to: determine a PSAP for the at least one UE based on the mapping table.
Aspect 25 is the apparatus of any of aspects 17 to 24, where the network entity includes at least one of a 5GC network or an IMS.
Aspect 26 is the apparatus of any of aspects 17 to 25, where the 5GC network or the IMS is associated with at least one of a P-CSCF, a GMLC, an LRF, or an AS.
Aspect 27 is the apparatus of any of aspects 17 to 26, where the ID of the non-network connection entity is received via the P-CSCF in IMS signaling at IMS registration, IMS emergency registration, IMS session initiation, or SMS over IP procedures.
Aspect 28 is the apparatus of any of aspects 17 to 27, where the non-network connection entity is a WLAN AP.
Aspect 29 is the apparatus of any of aspects 17 to 28, where the ID is an APN or an APN ID that is associated with the WLAN AP.
Aspect 30 is the apparatus of any of aspects 17 to 29, where the APN ID includes at least one of an SSID, a BSSID, or a LID.
Aspect 31 is the apparatus of any of aspects 17 to 30, where the non-network connection entity provides the UE with a non-3GPP access, and where the ID of the non-network connection entity is received via a N3IWF when the UE establishes a PDU session via the N3IWF.
Aspect 32 is the apparatus of any of aspects 17 to 31, where the ID is received in an IKE authorization request message associated with the PDU session establishment.
Aspect 33 is the apparatus of any of aspects 17 to 32, where the ID of the non-network

connection entity is received from a TWAN in a TWAN identifier.
Aspect 34 is a method of wireless communication for implementing any of aspects 17 to 33.
Aspect 33 is an apparatus for wireless communication including means for implementing any of aspects 17 to 33.
Aspect 34 is a computer-readable medium storing computer executable code, where the code when executed by a processor causes the processor to implement any of aspects 17 to 33.

What is claimed is:

1. An apparatus for wireless communication at a user equipment (UE), comprising:
a memory;
a transceiver; and
a processor, communicatively connected to the memory and the transceiver, the processor configured to:
establish a connection with at least one network entity and a non-network connection entity;
transmit, to the at least one network entity, an identifier (ID) of the non-network connection entity when connected to the at least one network entity;
receive, from the at least one network entity, a request for a location of the non-network connection entity; and
transmit, to the at least one network entity, an indication of location information for the non-network connection entity.

2. The apparatus of claim 1, wherein the at least one network entity includes at least one of a 5G Core (5GC) network or an IP multimedia subsystem (IMS).

3. The apparatus of claim 2, wherein the 5GC network or the IMS is associated with at least one of a proxy-call session control function (P-CSCF), a gateway mobile location center (GMLC), a location retrieval function (LRF), or an application server (AS).

4. The apparatus of claim 3, wherein the ID of the non-network connection entity is transmitted to the P-CSCF in IMS signaling at IMS registration, IMS emergency registration, IMS session initiation, or short message service (SMS) over IP procedures.

5. The apparatus of claim 1, wherein the non-network connection entity is a wireless local area network (WLAN) access point (AP).

6. The apparatus of claim 5, wherein the ID is an access point name (APN) or an APN ID that is associated with the WLAN AP.

7. The apparatus of claim 6, wherein the APN ID includes at least one of a service set identifier (SSID), a basic service set identifier (BSSID), or a line identifier (LID).

8. The apparatus of claim 1, wherein the non-network connection entity provides the UE with a non-3rd Generation Partnership Project (3GPP) access, and wherein the ID of the non-network connection entity is transmitted to a non-3GPP interworking function (N3IWF) when the UE establishes a protocol data unit (PDU) session with the N3IWF.

9. The apparatus of claim 8, wherein the ID is transmitted in an Internet key exchange (IKE) authorization request message associated with the PDU session establishment.

10. The apparatus of claim 1, wherein the processor is further configured to:
transmit, to the at least one network entity, a request for an emergency service.

11. The apparatus of claim 10, wherein the request for the emergency service includes a location information of the UE.

12. The apparatus of claim 11, further comprising a Global Navigation Satellite System (GNSS) receiver, wherein the location information is determined, at least in part, using the GNSS receiver.

13. A method of wireless communication at a user equipment (UE), comprising:
establishing a connection with at least one network entity and a non-network connection entity;
transmitting, to the at least one network entity, an identifier (ID) of the non-network connection entity when connected to the at least one network entity;
receiving, from the at least one network entity, a request for a location of the non-network connection entity; and
transmitting, to the at least one network entity, an indication of location information for the non-network connection entity.

14. An apparatus for wireless communication at a network entity, comprising:
a memory;
a transceiver; and
a processor, communicatively connected to the memory and the transceiver, the processor configured to:
establish a connection with at least one UE;
receive, from the at least one UE, an identifier (ID) of a non-network connection entity connected to the at least one UE;
transmit, to the at least one UE, a request for a location of the non-network connection entity;
receive, from the at least one UE, an indication of location information for the non-network connection entity; and
update, based on the received indication, a mapping table between the ID of the non-network connection entity and the location information for the non-network connection entity.

15. The apparatus of claim 14, wherein the processor is further configured to:
maintain the mapping table between the ID of the non-network connection entity and location information for the non-network connection entity.

16. The apparatus of claim 15, wherein the location associated with the non-network connection entity is determined based at least in part on the ID of the non-network connection entity.

17. The apparatus of claim 15, wherein the mapping table includes at least the ID, the location information for the non-network connection entity, and an age of the location information.

18. The apparatus of claim 14, wherein the processor is further configured to:
receive, from the at least one UE, a request for an emergency service; and
determine the location of the at least one UE based on the mapping table.

19. The apparatus of claim 18, wherein the processor is further configured to:
output the location of the at least one UE that connected to the non-network connection entity, when the emergency service is triggered, and no other method of location of the at least one UE is available.

20. The apparatus of claim 14, wherein the processor is further configured to:
determine a public-safety answering point (PSAP) for the at least one UE based on the mapping table.

21. The apparatus of claim 14, wherein the network entity includes at least one of a 5G Core (5GC) network or an IP multimedia subsystem (IMS).

22. The apparatus of claim 21, wherein the 5GC network or the IMS is associated with at least one of a proxy-call session control function (P-CSCF), a gateway mobile location center (GMLC), a location retrieval function (LRF), or an application server (AS).

23. The apparatus of claim 22, wherein the ID of the non-network connection entity is received via the P-CSCF in IMS signaling at IMS registration, IMS emergency registration, IMS session initiation, or short message service (SMS) over IP procedures.

24. The apparatus of claim 14, wherein the non-network connection entity is a wireless local area network (WLAN) access point (AP).

25. The apparatus of claim 24, wherein the ID is an access point name (APN) or an APN ID that is associated with the WLAN AP.

26. The apparatus of claim 25, wherein the APN ID includes at least one of a service set identifier (SSID), a basic service set identifier (BSSID), or a line identifier (LID).

27. The apparatus of claim 14, wherein the non-network connection entity provides the UE with a non-3rd Generation Partnership Project (3GPP) access, and wherein the ID of the non-network connection entity is received via a non-3GPP interworking function (N3IWF) when the at least one UE establishes a protocol data unit (PDU) session via the N3IWF.

28. The apparatus of claim 27, wherein the ID is received in an Internet key exchange (IKE) authorization request message associated with the PDU session establishment.

29. The apparatus of claim 14, wherein the ID of the non-network connection entity is received from a trusted wireless local area network (WLAN) access network (TWAN) in a TWAN identifier.

30. A method of wireless communication at a network entity, comprising:
establishing a connection with at least one UE;
receiving, from the at least one UE, an identifier (ID) of a non-network connection entity connected to the at least one UE;
transmitting, to the at least one UE, a request for a location of the non-network connection entity;
receiving, from the at least one UE, an indication of location information for the non-network connection entity; and
updating, based on the received indication, a mapping table between the ID of the non-network connection entity and the location information for the non-network connection entity.
